(19) United States
(12) Patent Application Publication
(10) Pub. No.: US 2009/0291322 A1
(43) Pub. Date: Nov. 26, 2009

(54) Joined body and process for manufacturing the same

(75) Inventors: Goro Watanabe, Tajimi-shi (JP); Tetsuya Suganuma, Chofu-shi (JP)

Correspondence Address: OLIFF & BERRIDGE, PLC, P.O. BOX 320850, ALEXANDRIA, VA, 22320-4850, US

(73) Assignee: KABUSHIKI KAISHA TOYOTA CHUO KENKYUSHO, AICHI-GUN (JP)

(21) Appl. No.: 12/453,662

(22) Filed: May 18, 2009

(30) Foreign Application Priority Data
May 26, 2008 (JP) 2008-136974

(51) Int. Cl. B32B 15/01; B23K 20/12

(52) U.S. Cl. 428/653; 228/112.1; 428/615; 428/654

(57) ABSTRACT

A joined body has a joint, which includes a first plate-shaped workpiece made of a first metal, and a second plate-shaped workpiece made of a second metal. The first plate-shaped workpiece, and the second plate-shaped workpiece are overlapped each other partially at least. The joint is made by means of friction stir joining by superimposing a rod-shaped body made of a third metal onto the overlapped first plate-shaped workpiece and second plate-shaped workpiece and then rotating it while pressing it onto the first plate-shaped workpiece. The joint further includes a coalesced section made of the first metal that coalesces on a surface of the second plate-shaped workpiece, a built-up section made of the third metal, and a composite section made of a mixture of the first metal and the third metal that integrates the coalesced section with the built-up section.

### INCORPORATION BY REFERENCE

The present invention is based on Japanese Patent Application No. 2008-136,974, filed on May 26, 2008, the entire contents of which are incorporated herein by reference.

### BACKGROUND OF THE INVENTION

1. Field of the Invention

The present invention relates to a joined body that is made by means of friction stir joining that might also be called as friction stir welding (or “FSW”), and a process for manufacturing the same.

2. Description of the Related Art

Conventionally, as a method of joining members that comprise different species of metallic materials or the same species, a resistant spot welding method has been available heretofore. In the resistant spot welding, an electric current is flowed through parts to be joined to melt the metallic materials that make the parts, and then the parts are joined together. However, according to such a method as the resistant spot welding method in which metallic materials are melted in order to carry out joining, no sufficient joining strength might be produced because brittle intermetallic compounds have been formed when joining a steel plate to an aluminum-alloy plate, for instance. Hence, the technology of friction stir joining has drawn engineers' attention recently. According to the technology, it is possible to join materials in solid-phase state without ever melting them.

Japanese Unexamined Patent Publication (KOKAI) Gazette No. 2001-314,982 discloses a joining method in which metallic members are joined together using a friction-stir-joining technology. According to the publication, while rotating a pin (21) comprising a tool steel, the pin (21) is pressed onto the joining point at which two pieces of aluminum-alloy plate-shaped workpieces (30, 31) are overlapped each other. The materials at around the joining point are heated by means of friction heat, and are then softened to cause plastic flows. Thereafter, the pin (21) is press fitted into the plate-shaped workpieces (30, 31) in their thickness-wise direction, thereby stirring the materials at around the boundary surface between the two plate-shaped work pieces (30, 31) to integrate them. Finally, the pin (21) is pulled out. Thus, the two aluminum-alloy plate-shaped workpieces are joined together. However, not only the materials around the joining point into which the pin (21) is press fitted are pushed out toward the outer-periphery side, but also the pin (21) that has been press fitted into the joining point upon joining is pulled out of the joining point eventually. Accordingly, a dent that coincides with the shape of the pin (21) has remained at the joining point as shown in FIG. 4 of the publication, thereby decreasing the thickness of the plate-shaped workpieces (30), one of the two plate-shaped workpieces (30, 31), locally. Consequently, the joined workpieces (30, 31) might not even produce sufficient strength depending on applications. Because of this drawback, Japanese Unexamined Patent Publication (KOKAI) Gazette No. 2002-120,077 proposes to compensate the strength shortage by filling the dent, which has resulted from the joining method that Japanese Unexamined Patent Publication (KOKAI) Gazette No. 2001-314,982 discloses, with a resin.

Moreover, Japanese Unexamined Patent Publication (KOKAI) Gazette No. 2002-219,584 recites a method of joining two members together using the following friction-stir-joining technology. That is, two members are provided with an inclined surface, respectively, at the facing opposite ends. The inclined surfaces demarcate a letter “V”-shaped bevel that is to be built up by means of friction stir joining. Specifically, a building-up workpiece is rotated while being pressed onto the inclined surfaces at one of the opposite ends, and thereby friction heat is generated. Then, the resulting friction heat softens the building-up workpiece, and the softened building-up workpiece is supplied toward the bevel. As a result, the two members are joined together by the building-up workpiece that intervenes between them.

When two plate-shaped workpieces are overlapped each other and are then subjected to friction stir joining, the above-described first conventional method that Japanese Unexamined Patent Publication (KOKAI) Gazette No. 2001-314,982 discloses has produced a joined part whose thickness is thin so that fractures might arise starting at the joined part with thinned thickness. Although it might be possible to prevent small fractures from occurring by supplementing the thinned section with a resin as set forth in Japanese Unexamined Patent Publication (KOKAI) Gazette No. 2002-120,077, it is difficult to improve the strength at the joint greatly when the adhesiveness is poor between the metal and the resin.

Moreover, according to Japanese Unexamined Patent Publication (KOKAI) Gazette No. 2002-219,584, the building-up workpiece makes it possible to provide the letter “V”-shaped bevel with a certain thickness. However, the opposite ends of the two members that face each other are not joined directly, namely, the two members are joined by way of the building-up workpiece. Therefore, the resultant joined assembly might associate with problems in view of strength.

### SUMMARY OF THE INVENTION

The present invention has been developed in view of such circumstances. Specifically, in friction stir joining for overlapped workpieces, it is an object of the present invention to provide a joined body whose plate thickness is hardly decreased at the joint and whose strength is high at the joint. Moreover, it is another object of the present invention to provide a process for manufacturing such a joined body.

A joined body according to the present invention has a joint,

the joint comprising:
a first plate-shaped workpiece comprising a first metal;
a second plate-shaped workpiece comprising a second metal; and
at least a part of the first plate-shaped workpiece and at least a part of the second plate-shaped workpiece being overlapped each other;

the joint being made by joining the first plate-shaped workpiece and the second plate-shaped workpiece to each other by means of friction stir joining, wherein a rod-shaped body comprising a third metal is disposed at a part where the first plate-shaped workpiece and the second plate-shaped workpiece overlap each other, and then the first plate-shaped workpiece and the second plate-shaped workpiece are rotated relatively with respect to the rod-shaped body while pressing the rod-shaped body onto the first plate-shaped workpiece; and

the joint further comprising:
a coalesced section being made of the first metal that coalesces on a surface of the second plate-shaped workpiece;
a built-up section being made of a leading end of the rod-shaped body that is buried in the first plate-shaped workpiece; and
a composite section being disposed between the coalesced section and the built-up section, and being made of the first metal and the third metal that are intermingled with each other, thereby integrating the coalesced section with the built-up section.

Moreover, a process for manufacturing joined body according to the present invention comprises the steps of:

fixing a first plate-shaped workpiece comprising a first metal and a second plate-shaped workpiece comprising a second metal in such a state that at least a part of the first plate-shaped workpiece and at least a part of the second plate-shaped workpiece are overlapped each other; and

subjecting the first plate-shaped workpiece and the second plate-shaped workpiece to friction stir joining, wherein a rod-shaped body comprising a third metal is disposed at a part where the first plate-shaped workpiece and the second plate-shaped workpiece overlap each other, and then the first plate-shaped workpiece and the second plate-shaped workpiece are rotated relatively with respect to the rod-shaped body while pressing the rod-shaped body onto the first plate-shaped workpiece, thereby softening and then fluidizing both of the first metal and the third metal by means of heat generation resulting from friction between the first plate-shaped workpiece and the rod-shaped body so as to coalesce the softened first metal onto a surface of the second plate-shaped workpiece and build up the first plate-shaped workpiece with the softened third metal.

Note that the designations, such as “first,” “second” and “third,” are designations for making the constituent elements, such the workpieces and bodies, distinct for the sake of convenience. Therefore, the “first metal” and “second metal,” for instance, can be either a metal with an identical composition or metals with different compositions.

When joining overlapped two plate-shaped workpieces by means of friction stir joining, a rod-shaped body (or a pin) that is harder than the plate-shaped workpieces are driven to rotate in order to join the plate-shaped workpieces according to the first conventional method that Japanese Unexamined Patent Publication (KOKAI) Gazette No. 2001-314,982 discloses. In this instance, although the friction heat softens the plate-shaped workpieces around the rod-shaped body to fluidize them, the rod-shaped body neither softens nor fluidizes. Thus, as described above, there has been such a problem that the dent has occurred at the joined section to make the plate thickness thinner at the joined section. On the other hand, according to the process for manufacturing joined body that is directed to the present invention, friction stir joining is carried out using a rod-shaped body that comprises a third metal. Note that the third metal softens along with a first metal that makes the first plate-shaped workpieces, one of the two plate-shaped workpieces to be joined together.

Specifically, according to the present manufacturing process, upon joining the first plate-shaped workpiece comprising a first metal and the second plate-shaped workpiece comprising a second metal after overlapping at least parts of them each other, the first plate-shaped workpiece and the second plate-shaped workpiece are rotated relatively with respect to the rod-shaped body comprising a third metal while pressing the rod-shaped body onto the first plate-shaped workpiece at the overlapped part. In this instance, not only the first metal is softened but also the third metal is softened by means of heat generation that results from the friction between the first plate-shaped workpiece and the rod-shaped body. As a result, in the surfaces where the first plate-shaped workpiece and the second plate-shaped workpiece overlap each other, the first metal, which is exposed to the rotating rod-shaped body, coalesces onto a surface of the second plate-shaped workpiece, and thereby the first plate-shaped workpiece and the second plate-shaped workpiece are joined to each other. At the same time, the third metal, which softens along with the first metal, forms a padding or built-up section. The resultant padding compensates for the thickness at the joined part. Moreover, since the third metal is mixed with the first metal, the padding integrates with the first plate-shaped workpiece. Therefore, the thus manufactured joined body according to the present invention exhibits enhanced strength at the joint.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is an explanatory cross-sectional diagram for schematically illustrating a process for manufacturing joined body according to an example of the present invention.

FIG. 2 is an explanatory cross-sectional diagram for schematically illustrating a joined body according to an example of the present invention in the thickness-wise direction.

FIG. 3 is an explanatory cross-sectional diagram for schematically illustrating a process for manufacturing joined body according to another example of the present invention.

FIG. 4 is an explanatory cross-sectional diagram for illustrating a process for manufacturing joined body according to Example No. 1-1 of the present invention.

FIG. 5 is a photograph that substitutes for a drawing for showing a cross section of a joined body according to Example No. 1-1 at the joint.

FIG. 6 is an explanatory cross-sectional diagram for illustrating a process for manufacturing joined body according to Example No. 1-2 of the present invention.

FIG. 7 is a photograph that substitutes for a drawing for showing a cross section of a joined body according to Example No. 1-2 at the joint.

FIG. 8 is a photograph that substitutes for a drawing for showing a major portion of FIG. 7 in (enlarged view.

FIG. 9 is a photograph that substitutes for a drawing for showing a major portion of FIG. 8 in enlarged view.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

Preferable modes for carrying out a joined body according to present invention and a process for manufacturing the same will be hereinafter described.

### Joined Body

A joined body according to the present invention has a joint. The joint comprises a first plate-shaped workpiece, and a second plate-shaped workpiece. The first plate-shaped workpiece comprises a first metal. The second plate-shaped workpiece comprises a second metal. At least a part of the first plate-shaped workpiece, and at least a part of the second plate-shaped workpiece are overlapped each other. The first plate-shaped workpiece, and the second plate-shaped workpiece are subjected to friction stir joining in order to join them to each other and make the joint.

The first plate-shaped workpiece and second plate-shaped workpiece are not limited in terms of their shapes as far as at least their sections at which they are subjected to friction stir joining are formed as a plate shape. The first plate-shaped workpiece can preferably have a thickness of from 0.2 to 10 mm, further preferably from 0.5 to 2 mm, at least at the section to be subjected to friction stir joining. Note that the second plate-shaped workpiece is not limited especially in terms of the thickness. However, the second plate-shaped workpiece can preferably have a thickness of from 0.2 to 10 mm, further preferably from 0.5 to 4 mm, at least at the section to be subjected to friction stir joining. It is not preferable that the thickness of the first plate-shaped workpiece and second plate-shaped workpiece is too thin, because the workpieces might deform depending on pressurizing force or rotary force. Moreover, it is not preferable either that the thickness of the first plate-shaped workpiece and second plate-shaped workpiece is too thick, because the construction of apparatus for manufacturing joined body might become too gigantic in accordance with the similarity rule.

The first plate-shaped workpiece comprises a first metal. The second plate-shaped workpiece comprises a second metal. The first metal, and the second metal can be the same species of metal, or can even be different species of metals. Specifically, as for the first and second metals, it is possible to name aluminum, an aluminum alloy whose major component is aluminum, magnesium, a magnesium alloy whose major component is magnesium, a copper alloy, iron, and a steel. The aluminum alloy can be A6061, A2017, or A5052 according to JIS (i.e., Japanese Industrial Standards). The magnesium alloy can be AZ31, AZ61, or AZ80 according to JIS. The steel can be soft steels, high-tensile steels, alloy steels, or various plated steels.

The joint can be made in the following manner, for instance: the first plate-shaped workpiece, and the second plate-shaped workpiece are overlapped each other; a rod-shaped body comprising a third metal is pressed onto a part where the first plate-shaped workpiece and the second plate-shaped workpiece overlap each other; and then the first plate-shaped workpiece and the second plate-shaped workpiece are rotated relatively with respect to the rod-shaped body that is kept being pressed onto the part in the first plate-shaped workpiece, thereby joining the first plate-shaped workpiece and the second plate-shaped workpiece to each other by means of friction stir joining. It is allowable that the joint can be present partially at least at the part where the first plate-shaped workpiece and the second plate-shaped workpiece overlap each other. That is, it is permissible that the first plate-shaped workpiece and the second plate-shaped workpiece can be joined by the joint at a single location, or they can be joined by the joints at multiple locations. Note that the joining method by means of friction stir joining will be described later.

It is allowable that the rod-shaped body can be formed as a rod shape at least at the leading end that is to be pressed onto the first plate-shaped workpiece. Although it is preferable to provide the leading end of the rod-shaped body with a cylindrical shape, it is permissible to provide the leading end with such a shape that is enlarged diametrically or reduced diametrically in the axial direction to give the outer peripheral surface a slightly inclined shape. When the rod-shaped body is formed as a cylindrical shape, it can preferably have a diameter that falls in a range of from 1 to 20 mm, further preferably from 5 to 15 mm. Moreover, the rod-shaped body can preferably have an end surface, namely, a surface to be pressed onto a surface of the first plate-shaped workpiece, which is formed as a flat surface. However, it is allowable as well to form the end surface as a curved surface that protrudes slightly.

The rod-shaped body comprises a third metal. As being described below, heat generation resulting from the friction that arises from friction stir joining softens and then fluidizes the third metal along with the first metal. Then, the thus softened and fluidized third metal and first metal form the joint. Accordingly, it is preferable that the third metal can comprise a metal whose deformation resistance at high temperature is equal to that of the first metal. For example, it is allowable that the third metal can be made of a metal that softens in a temperature range that overlaps a temperature range where the first metal softens. Therefore, it is permissible that the first metal and the third metal can comprise the same metal with each other, or can comprise metals of the same kind to each other. For instance, it is preferable that the first metal and the third metal can comprise an identical metallic element as a major component. When the first metal and the third metal comprise an identical metal, or a material that is selected from the group consisting of alloys including an identical metal as a major component, respectively, both of the first plate-shaped workpiece and rod-shaped body come to exhibit similar physical properties so that they are softened and then fluidized at the same time by heat generation that results from friction stir joining. For example, when aluminum or an aluminum alloy is used to make the first plate-shaped workpiece and rod-shaped body, heat generation that arises from friction can soften and then fluidize both of the first plate-shaped workpiece and rod-shaped body simultaneously even if they have different compositions to each other.

The joint further comprises a coalesced section, a built-up section, and a composite section. The coalesced section is made of the first metal that coalesces on a surface of the second plate-shaped workpiece. Since the first metal is softened by heat generation resulting from friction and is then coalesced on a surface of the second plate-shaped workpiece, the first plate-shaped workpiece and second plate-shaped workpiece are joined firmly at the boundary surface. The built-up section is made of a leading end of the rod-shaped body that is buried in the first plate-shaped workpiece. The built-up section compensates the first plate-shaped workpiece for the thickness that is reduced because the rod-shaped body is pressed onto the first plate-shaped workpiece. The composite section is disposed between the coalesced section and the built-up section. Moreover, the composite section is made of the first metal and the third metal that are intermingled with each other, thereby integrating the coalesced section with the built-up section. That is, the coalesced section and the built-up section exist in such a manner that they are connected with each other in a solid-phase state, because the third metal, which is softened together with the first metal by heat generation that arises from friction, coexists with the first metal. That is, the built-up section is integrated with the first plate-shaped workpiece. As a result, the joined body according to the present invention exhibits upgraded strength at the joint. Note that the joint can preferably comprise the coalesced section in an amount of from 0.1 to 30% by mass, the built-up section in an amount of from 30 to 70% by mass, and the composite section in an amount of 10 to 70% by mass, when the entire joint is taken as 100% mass. Moreover, the composite section can preferably comprise the first metal in an amount of from 20 to 60% by mass, the third metal in an amount of from 40 to 80% by mass, and the balance of inevitable impurities, when the entire composite section is taken as 100% by mass.

As described above, the first plate-shaped workpiece and the second plate-shaped workpiece are joined to each other at the joint by means of the coalescence of the first metal with the second metal. Accordingly, when the first metal and the second metal comprise a combination of metals that are likely to coalesce each other, the joined body according to the present invention is joined more firmly at the joint. For example, it has been known that aluminum and iron make a combination in which seizure is likely to occur particularly. Consequently, a combination of the first metal comprising aluminum or an aluminum alloy and the second metal comprising iron or a steel is one of optimum options for constituting the present joined body.

### Process for Manufacturing Joined Body

A process for manufacturing joined body according to the present invention will be herein after detailed using the accompanying drawings.

A process for manufacturing joined body according to the present invention is a process that makes the above-described present joined body available by coalescing the softened first metal onto a surface of the second plate-shaped workpiece and then building up the first plate-shaped workpiece with the softened third metal. The present manufacturing process comprises a step of fixing workpieces, and a step of friction stir joining. Hereinafter, the respective steps will be described in detail.

The workpieces fixing step is a step of fixing a first plate-shaped workpiece comprising a first metal and a second plate-shaped workpiece comprising a second metal in such a state that at least a part of the first plate-shaped workpiece and at least a part of the second plate-shaped workpiece are overlapped each other. It is allowable that the first plate-shaped workpiece and the second plate-shaped workpiece are fixed to such an extent that they do not cause or suffer from any positional deviation or displacement in the subsequent step of friction stir joining.

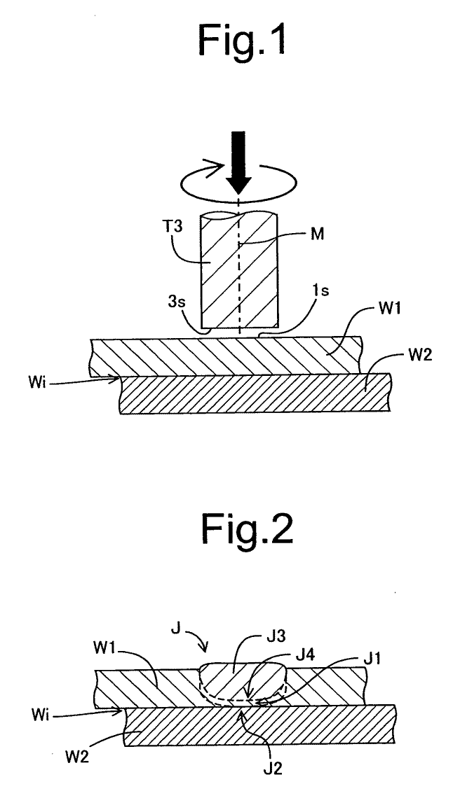

The friction-stir-joining step is a step of rotating the first plate-shaped workpiece and the second plate-shaped workpiece relatively with respect to a rod-shaped member comprising a third metal while pressing the rod-shaped body onto the first plate-shaped workpiece at a part where the first plate member and the second plate member overlap each other. FIG. 1 is an explanatory diagram for illustrating an example of the process for manufacturing joined body according to the present invention, and shows the first plate-shaped workpiece, the second plate-shaped workpiece and the rod-shaped body in the cross-section view, respectively. As illustrated in the drawing, at the workpieces fixing step, the first plate-shaped workpiece “W1” and the second plate-shaped workpiece “W2” are overlapped each other in the thickness-wise direction. The cylindrically-configured rod-shaped body “T3” is put in place above the first plate-shaped workpiece “W1” so as to make the central axis “M” parallel to the thickness-wise direction of the first plate-shaped workpiece “W1” and second plate-shaped workpiece “W2.” At the friction-stir-joining step, the rod-shaped body “T3” is rotated about the central axis “M.” Then, the rod-shaped body “T3” is moved parallelly to the central axis “M,” that is, in the thickness-wise direction of the first plate-shaped workpiece “W1” and second plate-shaped workpiece “W2” to press the end surface “3s” of the rod-shaped body “T3” onto a surface “1s” of the first plate-shaped workpiece “W1.”

At the friction-stir-joining step, heat generation resulting from friction softens and then fluidizes both of the first metal and third metal. Both of the thus softened and then fluidized first metal and third metal form a joint that comprises a coalesced section and a built-up section. FIG. 2 is a cross-sectional diagram for illustrating a joined body according to the present invention in the thickness-wise direction. At the friction stir joining step, the rod-shaped body “T3” is pressed onto the surface “1s” of the first plate-shaped workpiece “W1” while being rotated as shown in FIG. 1, thereby producing heat by means of the friction between them. In this instance, the first metal making the first plate-shaped workpiece “W1,” and the third metal making the rod-shaped body “T3” are softened and then fluidized by means of heat generation resulting from the friction. Moreover, the rod-shaped body “T3” presses the first plate-shaped workpiece “W1” toward the second plate-shaped workpiece “W2.” In addition, the rod-shaped body “T3” is pressed into the first plate-shaped workpiece “W1” because the first metal is softened locally in the first plate-shaped workpiece “W1.” Under the circumstances, the leading end of the rod-shaped body “T3” is put in such a state that it is buried in the softened part of the first plate-shaped workpiece “W1.” The rotating rod-shaped body “T3” mixes the first metal and the third metal in such a state that they are present in solid phase partially at least, and then forms a composite section “J4” in which the first metal and the third metal are intermingled with each other. The first metal around the rod-shaped body “T3” rotates together with the rod-shaped body “T3” because the first metal is connected with the rod-shaped body “T3” in a solid-phase state. Accordingly, when the pressed rod-shaped body “T3” reaches at around a faying surface “W1” where the first plate-shaped workpiece “W1” and the second plate-shaped workpiece “W2” overlap each other, the first metal, which is stirred by the rotating rod-shaped body “T3,” coalesces onto a surface of the second plate-shaped workpiece “W2” in a vicinity “J1” adjacent to the faying surface “W1.” Consequently, at the friction-stir-joining step, a joint “J” is produced. Note that the thus formed joint “J” comprises a coalesced section “J2,” a built-up section “J3,” and a composite section “J4.” The coalesced section “J2” comprises the first metal that is softened and then fluidized by heat generation resulting from the friction, and the coalesced section “J2” coalesces on the surface of the second plate-shaped workpiece “W2.” The built-up section “J3” comprises the leading end of the rod-shaped body “T3” that is buried in the first plate-shaped workpiece “W1.” The composite section “J4” comprises the first metal and the third metal, and integrates the coalesced section “J2” with the built-up section “J3.”

Note that, at the friction stir joining step, it is allowable to press the rod-shaped body “T3” into the first plate-shaped workpiece “W1” by a predetermined pressing magnitude and thereafter hold the rod-shaped body “T3” in the resulting pressed state for a predetermined period of time. While the rod-shaped body “T3” is kept in the pressed state, the boundary surface between the fluidizing part of the rod-shaped body “T3” and the fluidizing-free part moves in the opposite direction to the pressing direction. Then, when the rod-shaped body “T3” is separated from the first plate-shaped workpiece “W1,” the rod-shaped body “T3” is removed from the resultant joined body at around the boundary surface. Thus, it is possible to provide a surface of the first plate-shaped workpiece “W1” with the built-up section “J3” having a desirable thickness by controlling the time for holding the rod-shaped body “T3” in the pressed state. Note that the pressing magnitude will be described later in the present specification.

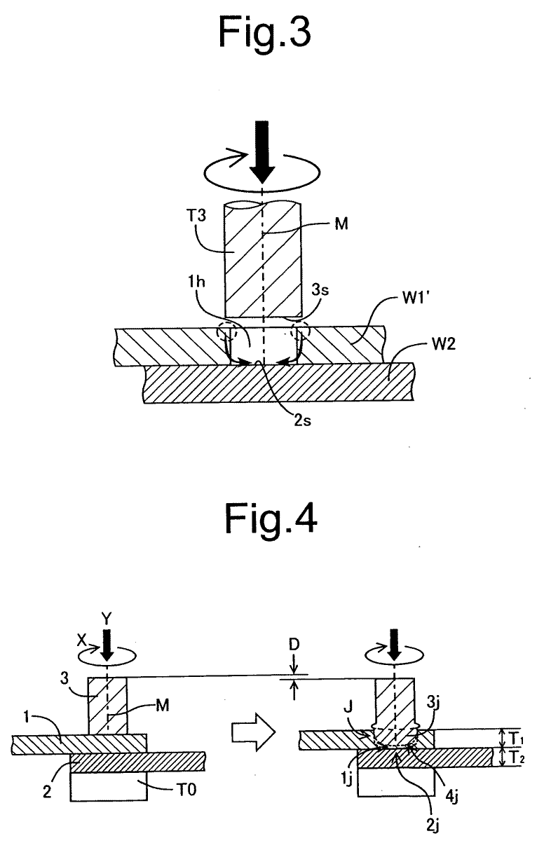

Moreover, it is allowable that the process for manufacturing joined body according to the present invention can further comprise a through-hole forming step that is carried out prior to the workpieces fixing step. For example, before the workpieces fixing step, the first plate-shaped workpiece is provided with a through hole with a circular cross-sectional shape at the through-hole forming step. Note that the through hole has a smaller diameter than that of the rod-shaped body and penetrates the first plate-shaped workpiece in the thickness-wise direction. That is, at the workpieces fixing step following the through-hole forming step, the resulting through hole of the first plate-shaped workpiece is superimposed over a surface of the second plate-shaped workpiece. Then, at the subsequent friction-stir-joining step, the rod-shaped body is pressed onto the first plate-shaped workpiece to press fit the leading end into the through hole. Thus, subjecting the first plate-shaped workpiece with the through hole being provided to friction stir joining makes it likewise possible to form the joint that is directed to the present invention. FIG. 3 illustrates an example of the above-described modified version of the process for manufacturing joined body according to the present invention in an explanatory diagram, and shows the first plate-shaped workpiece, the second plate-shaped workpiece and the rod-shaped body in the cross-sectional view, respectively. As illustrated in the drawing, a first plate-shaped workpiece “W1′” comprises a through hole “1h.” The through hole “1h” penetrates the first plate-shaped workpiece “W1′” in the thickness-wise direction, and has a cross-sectionally circular shape. At the workpieces fixing step, the first plate-shaped workpiece “W1′” and the second plate-shaped workpiece “W2” are overlapped each other in the thickness-wise direction. In this instance, the through hole “1h” is covered with a surface “2s” of the second plate-shaped workpiece “W2” at one of the opposite openings. Not only the rod-shaped body “T3” with a cylindrical shape is put in place so that the central “M” is parallel to the thickness-wise direction of the first plate-shaped workpiece “W1′” and second plate-shaped workpiece “W2,” but also the rod-shaped body “T3” is put in place above the first plate-shaped workpiece “W1′” and coaxially with the through hole “1h.” Then, at the friction-stir-joining step, the rod-shaped body “T3” is driven so as to move parallelly to the central axis “M” while being rotated about the central axis “M.” Thus, an end surface “3s” of the rod-shaped body “T3” is pressed onto the first plate-shaped workpiece “W1′,” and then the rod-shaped body “T3” is press fitted into the through hole “1s.” On this occasion, the peripheral edge of the end surface “3s” of the rod-shaped body “T3” crushes down the opening end of the through hole “1s” that is specified with the dotted-lined circles in the drawing, and thereby the first metal at the section is softened and then fluidized by heat generation that results from the friction between the rod-shaped body “T3” and the first plate-shaped workpiece “W1′.” The softened first metal flows toward the surface “2s” of the second plate-shaped workpiece “W2” in the directions that are specified with the arrows in the drawing. Moreover, in the same manner as described above, the rotating rod-shaped body “T3” flows the softened first metal toward the surface “2s” of the second plate-shaped workpiece “W2” and then coalesces the first metal on the surface “2s.” In addition, the third metal making the rod-shaped body “T3” softens likewise as the first metal does. All in all, the softened first metal and third metal produce the joint “J” eventually, joint “J” which comprises the coalesced section “J2,” the built-up section “J3” and the composite section “J4” as shown in FIG. 2.

When press fitting the rod-shaped body “T3” into the through hole “1h” that has been formed in the first plate-shaped workpiece “W1′” in advance and then carrying out friction stir joining, the first metal undergoes plastic flow that is accompanied by great deformation as described above. On the surface of the second plate-shaped workpiece “W2,” not only a newly-arising surface of the first metal is exposed, but also the first metal is stirred by the rotating rod-shaped body “T3” efficiently. Because of this, the first metal coalesces on the surface of the second plate-shaped workpiece “W2” firmly. As a result, the resulting present joined body comprises a joint that exhibits improved strength.

The through hole can preferably be formed as a cylindrical shape. However, it is allowable that the through hole can have a shape that enlarges diametrically, namely, whose diameter is larger at the inlet opening end for the rod-shaped body than at the leading end, so that the inner peripheral surface inclines from large to small diametrically in the thickness-wise direction of the first plate-shaped workpiece. When the through hole has a cylindrical shape, its inside diameter can preferably be smaller than the rod-shaped body's outside diameter by 1 mm or more, further preferably by 2 mm or more. When the difference between the outside diameter and the inside diameter is smaller than 1 mm, it becomes difficult to build up between the rod-shaped body and the first plate-shaped workpiece without ever making any void. Thus, such a diametric difference is not preferable. Specifically, the through hole's inside diameter can preferably be smaller than the rod-shaped body's outside diameter by a factor of from 0.3 to 0.9, more preferably from 0.4 to 0.8, much more preferably from 0.5 to 0.7, for instance.

At the friction-stir-joining step, it is allowable to set a rotating speed of the rod-shaped body, and a pressing speed of the rod-shaped body into the first plate-shaped workpiece to such an extent that the rod-shaped body and the first plate-shaped workpiece around the rod-shaped body generate heat enabling both of the first metal and third metal to soften and then fluidize. For example, it is permissible to set the rotating speed to fall in a range of from 300 to 4,000 rpm, further from 1,000 to 2,000 rpm. When the rod-shaped body rotates at a rotating speed of 300 rpm or more, the friction between the rod-shaped body and the first plate-shaped workpiece generates heat sufficiently. On the other hand, rotating the rod-shaped body at a rotating speed of more than 4,000 rpm is not desirable because it is less likely to control the fluctuation of heat generation that results from the friction. Moreover, it is allowable to press the rod-shaped body into the first plate-shaped workpiece at a pressing speed of from 10 to 200 mm/min., further from 20 to 100 mm/min.

In addition, at the friction-stir-joining step, it is permissible to set the pressing magnitude of the rod-shaped body depending on the thickness of the first plate-shaped workpiece. Note that the “pressing magnitude” in the present specification is determined based on a state in which the leading end of the rod-shaped body comes in contact with a surface of the first plate-shaped workpiece. That is, a distance that the rod-shaped body has traveled from a position at which the leading end contacts the first plate-shaped workpiece's surface is considered the pressing magnitude. For example, when the thickness of the first plate-shaped workpiece is “T₁,” it is desirable to set the pressing magnitude to fall in a range of from (“T₁”×0.4) mm or more to (“T₁”×2.0) mm or less, further desirably from (“T₁”×0.6) mm or more to (“T₁”×1.5) mm or less. Moreover, when the first plate-shaped workpiece is provided with a through hole, it is desirable to set the pressing magnitude to fall in a range of from (“T₁”×0.6) mm or more to (“T₁”×3.0) mm or less, further desirably from (“T₁”1.0) mm or more to (“T₁”2.0) mm or less. Setting the pressing magnitude of the rod-shaped body so as to fall in these ranges enables the first metal to coalesce onto a surface of the second plate-shaped workpiece favorably. Although an axial pressure for pressing the rod-shaped body into the first plate-shaped workpiece depends on the type and size of materials that make the first plate-shaped workpiece, second plate-shaped workpiece and rod-shaped body, it is preferable in general to press the rod-shaped body into the first plate-shaped workpiece with an axial pressure of from 10 to 150 MPa, more preferably from 20 to 100 MPa, much more preferably from 30 to 50 MPa, for instance.

Moreover, the friction-stir-joining step can be carried out at any temperature and in any atmosphere, and accordingly it is feasible to carry it out even at room temperature in air, for instance. However, when at least one of the first metal and third metal comprises an active material, it is preferable to carry out the friction-stir-joining step in an atmosphere of inert gas, such as nitrogen or argon, or in a vacuum. Note that, regarding the processing temperature, heat generation resulting from friction raises the temperatures of the first plate-shaped workpiece and rod-shaped body with time even when the rod-shaped body is pressed into the first plate-shaped workpiece even at room temperature. In addition, it is allowable to carry out the friction stir joining step with an apparatus that is provided with a heater/cooler for heating/cooling at least one of the first plate-shaped workpiece, second plate-shaped workpiece and rod-shaped body.

Although the embodiment modes of the joined body and processes for manufacturing the same according to the present invention have been described so far, the present invention is not limited to the above-described embodiment modes. The present invention can be conducted in various modes to which modifications and improvements are performed, modification and improvements which one of ordinary skill in the art can carry out, within a range not departing from the scope of the present invention.

### EXAMPLES

Hereinafter, the present invention will be described in more detail with reference to examples of the joined body and process for manufacturing the same according to the present invention.

### Example No. 1-1

A joining method according to Example No. 1-1 of the present invention will be described using FIG. 4. The drawing is an explanatory diagram for illustrating the joining method that will be described below, and shows plate-shaped workpieces to be joined in their cross-sectional view in the thickness-wise direction.

As the plate-shaped workpieces to be joined, the following were prepared: an aluminum-alloy plate 1, and a soft-steel plate 2. The aluminum-alloy plate 1 was made of “A6061” aluminum alloy according to JIS, and had a thickness “T₁” of 1 mm. The soft-steel plate 2 was made of “SPC” steel according to JIS, and had a thickness “T₂” of 0.8 mm. Moreover, both of the aluminum-alloy plate 1 and soft-steel plate 2 were formed as a strip shape, respectively. In addition, as a rod-shaped body, an aluminum-alloy round bar 3 was prepared. The aluminum-alloy round bar 3 was made of “A2017” aluminum alloy according to JIS, and had a diameter of φ10 mm.

One of the opposite ends of the aluminum-alloy plate 1, and one of the opposite ends of the soft-steel plate 2 were overlapped each other by 40 mm respectively in their longitudinal direction. Then, the overlapped part with an area of 1,600 mm² (i.e., 40 mm×40 mm) was joined together at the middle by the following procedures. Thus, a joined body with an overall length of 200 mm was made.

In order to join the aluminum-alloy plate 1 and the soft-steel plate 2 together, a usual vertical friction testing machine being equipped with a rotary pressurizing mechanism was used. One of the opposite ends of the soft-steel plate 2 was placed on a retainer “T0” of the testing machine. Subsequently, one of the opposite ends of the aluminum-alloy plate 1 was superimposed onto the one of the opposite ends of the soft-steel plate 2 so as to make an overlapped portion with a predetermined length (i.e., 40 mm). Thereafter, the aluminum-alloy plate 1 and the soft-steel plate 2 were fixed on the retainer “T0” so as not to rotate each other. Finally, the aluminum-alloy round bar 3 was put in place over the aluminum-alloy plate 1 and the soft-alloy plate 2. On this occasion, the central axis “M” of the aluminum-alloy round bar 3 passed the center of the part where the aluminum-alloy plate 1 and the soft-steel plate 2 overlapped each other, and coincided with the thickness-wise direction of them (i.e., a plate-shaped workpieces fixing step).

After the plate-shaped workpieces fixing step, the aluminum-alloy round bar 3 was moved parallelly to the central axis “M” in the arrowed direction “Y” in FIG. 4 at room temperature in air while being rotated in the arrowed direction “X” in the drawing. On this occasion, the rotating speed of the aluminum-alloy round bar 3 was set at 1,000 rpm, and the pressing speed was at set 30 mm/min. Moreover, the pressing magnitude “D” of the aluminum-alloy round bar 3 was controlled to fall in a range of from 0.8 to 1.2 mm from the top surface of the aluminum-alloy plate 1. In addition, the aluminum-alloy round bar 3 was pressed into the aluminum-alloy plate 1 with an axial pressure of about 100 MPa. Note that the aluminum-alloy round bar 3 was stopped moving when it moved downward to reach the predetermined magnitude “D” and was then kept rotating at the same location for 2 seconds. At the time of starting pressing the aluminum-alloy round bar 3 in, the end surface of the aluminum-alloy round bar 3 and the top surface of the aluminum-plate 1 made a sliding surface. However, the sliding surface moved upward when stopping pressing the aluminum-alloy round bar 3 in (i.e., a friction-stir-joining step).

Thereafter, the aluminum-alloy round bar 3 was pulled upward to finish the joining. In accordance with the above-described procedures, five joined bodies were made. Each of the joined bodies' joint “J” was provided with a built-up weld that swelled up by 1 mm approximately from the top surface of the aluminum-alloy plate 1.

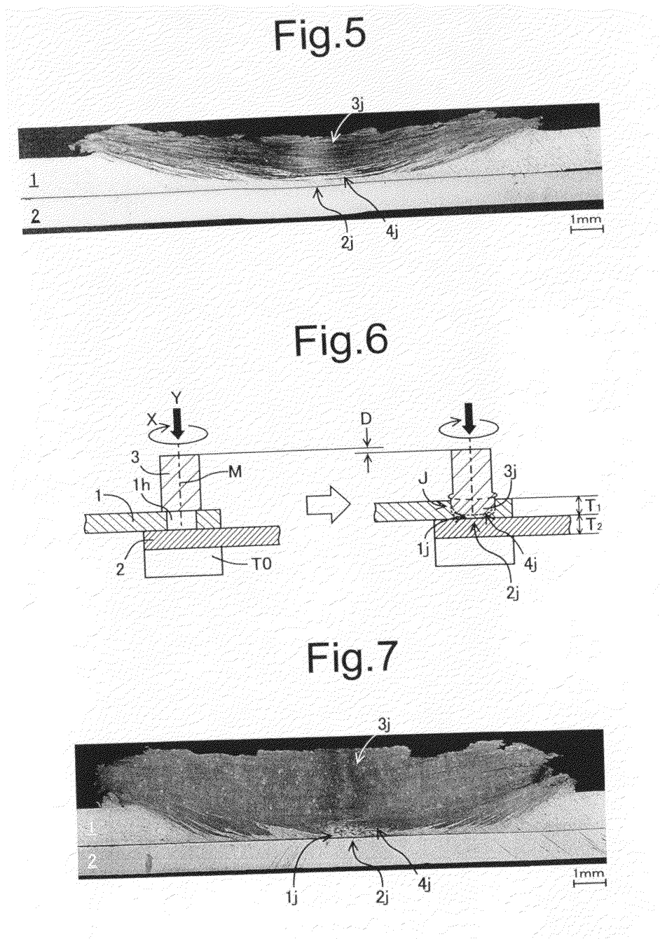

Moreover, the joined bodies that were manufactured in accordance with Example No. 1-1 of the present invention were observed for their cross section. The cross-sectional observation was carried out by observing the joint “J” of the resulting joined bodies with a metallographic microscope after cutting out and then etching their thickness-wise-direction cross section with the Keller liquid. FIG. 5 shows one of the results of the cross-sectional observation. In the drawing, the part with dark color that is seen on the top surface of the aluminum-alloy plate 1 is a built-up section “3j” that comprised the “A2027” aluminum alloy making the rod-shaped body 3. Moreover, between the built-up section “3j” and the aluminum-alloy plate 1, a composite section “4j” that comprised a mixture of the “A6061” aluminum alloy making the aluminum-alloy plate 1 and the “A2027” aluminum alloy making the aluminum-alloy round bar 3 is seen, and the aluminum-alloy plate 1 and the built-up section “3j” were integrated with each other. In addition, under the built-up section “3j,” a coalesced section “2j” that comprised the “A6061” aluminum alloy making the aluminum-alloy plate 1 is seen to exist. Note that the coalesced section “2j” was formed in the following fashion: not only the “A6061” aluminum alloy (i.e., a first metal) softened and then fluidized at the friction stir joining step to coalesce onto the surface of the soft-steel plate 2 but also it integrated with the “A2027” aluminum alloy (i.e., a third metal) making the built-up section “3j.”

### Example No. 1-2

A joining method according to Example No. 1-2 of the present invention will be described using FIG. 6. The drawing is an explanatory diagram for illustrating the joining method that will be described below, and shows plate-shaped workpieces to be joined in their cross-sectional view in the thickness-wise direction.

As the plate-shaped workpieces to be joined, the above-described aluminum-alloy plate 1 and soft-steel plate 2 were prepared. Moreover, as the rod-shaped body, the above-described aluminum-alloy round bar 3 was prepared likewise. Then, in accordance with the following procedures, a joined body with an overall length of 200 mm was made. That is, one of the opposite ends of the aluminum-alloy plate 1, and one of the opposite ends of the soft-steel plate 2 were overlapped each other by 40 mm respectively in their longitudinal direction. Then, the overlapped part with an area of 1,600 mm² (i.e., 40 mm×40 mm) was joined together at the middle.

Note that, in the joining method according to Example No. 1-2 of the present invention, the aluminum-alloy plate 1 had been provided with a through hole “1h” at one of the opposite ends in advance. The through hole “1h” penetrated the aluminum-alloy plate 1 in the thickness-wise direction, and had an inside diameter of φ7 mm. Moreover, the center of the through hole “1h” was disposed at a position that was away from each of three sides, which demarcated the one of the opposite ends of the aluminum-alloy plate 1, by 20 mm.

The aluminum-alloy plate 1 and the soft-alloy plate 2 were joined together using the same vertical friction testing machine as that was used in above-described Example No. 1-1. Then, as illustrated in FIG. 6, one of the opposite ends of the soft-steel plate 2 was placed on a retainer “T0” of the testing machine similarly. Subsequently, the through hole “1h” of the aluminum-alloy plate 1 was superimposed over the one of the opposite ends of the soft-steel plate 2 so that the one of the opposite ends of the aluminum-alloy plate 1 and the one of the opposite ends of the soft-steel alloy plate 2 made an overlapped portion with a predetermined length (i.e., 40 mm). Thereafter, the aluminum-alloy plate 1, and the soft-steel plate 2 were fixed likewise on the retainer “T0” so as not to rotate each other. Finally, the aluminum-alloy round bar 3 was similarly put in place over the aluminum-alloy plate 1 and the soft-alloy plate 2. In this instance, the central axis “M” of the aluminum-alloy round bar 3 coincided with the center of the through hole “1h” at the one of the opposite ends of the aluminum-alloy plate 1 (i.e., a plate-shaped workpieces fixing step).

In the end, except that the aluminum-alloy round bar 3 was fitted into the through hole “1h” of the aluminum-alloy plate 1 by a pressing magnitude “D” of 1.4 mm, the aluminum-alloy plate 1 and the soft-alloy plate 2 were joined to each other in the same manner as above-described Example No. 1-1 (i.e., a friction stir joining step). On this occasion, note that the aluminum-alloy round bar 3 was press fitted into the through hole “1h” of the aluminum-alloy plate 1 with an axial pressure of about 40 MPa.

In accordance with the above-described procedures, three joined bodies were made. Each of the joined bodies' joint “J” was provided with a built-up weld that swelled up by 1 mm approximately from the top surface of the aluminum-alloy plate 1.

Moreover, the joined bodies that were manufactured in accordance with Example No. 1-2 of the present invention were likewise subjected to a cross-sectional observation. That is, the joint “J” of the resulting joined bodies was cut out in the thickness-wise direction. The resulting cross section of the respective joints “J” was etched with the Keller liquid, and was then observed with a metallographic microscope. One of the results of the cross-sectional observation is shown in FIG. 7. In the drawing, a built-up section “3j” is observed as the part with dark color on the top surface of the aluminum-alloy plate 1. The built-up section “3j” comprised the “A2027” aluminum alloy that made the aluminum-alloy round bar 3. Note that the built-up section “3j” fills up the through hole “1h” completely. Moreover, a composite section “4j” is observed between the built-up section “3j” and the aluminum-alloy plate 1. The composite section “4j” comprised a mixture of the “A6061” aluminum alloy that made the aluminum-alloy plate 1 and the “A2027” aluminum alloy that made the aluminum-alloy round bar 3. Note that the aluminum-alloy plate 1 and the built-up section “3j” integrate one another. In addition, a coalesced section “2j” is observed to exist under the built-up section “3j.” The coalesced section “2j” comprised the “A6061” aluminum alloy that made the aluminum-alloy plate 1. Note that the coalesced section “2j” not only coalesces onto the surface of the soft-steel plate 2 but also integrates with the built-up section “3j,” because the “A6061” aluminum alloy (i.e., a first metal) making the aluminum-alloy plate 1 has softened and then fluidized at the friction stir joining step so that it coalesces and then integrates with the “A2027” aluminum alloy (i.e., a third metal) making the aluminum-alloy round bar 3.

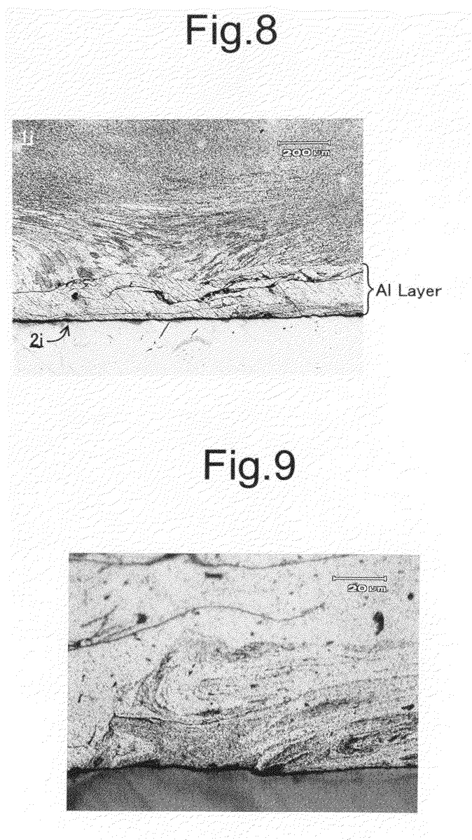

In addition, the image of the coalesced portion “2j” was enlarged to observe it. FIGS. 8 and 9 show the results of the observation on a boundary part of the coalesced portion “2j,” which was adjacent to the designation “1j” in FIG. 7, in an enlarged manner. As shown in the drawings, an aluminum layer having a thickness of 200 μm approximately is seen on the surface of the soft-steel plate 2. The aluminum layer comprised the “A6061” aluminum alloy (i.e., a first metal) that made the aluminum-alloy plate 1. It is believed that the aluminum layer was formed in the following manner. That is, the aluminum-alloy round bar 3 crushed down the “A6061” aluminum alloy that made the opening end of the through hole “1h” initially in the friction stir joining step. Then, heat generation resulting from the friction between the through hole “1h” and the aluminum-alloy round bar 3 softened the “A6061” aluminum alloy. The thus softened “A6061” aluminum alloy eventually flowed onto the surface of the soft-steel plate 2 to form the aluminum layer.

### Comparative Example No. 1

As the plate-shaped workpieces to be joined, the above-described aluminum-alloy plate 1 and soft-steel plate 2 were prepared. However, as the rod-shaped body, a round bar being made of steel was prepared. Note that the round bar was made of a tool steel (or a pre-hardened steel with a Rockwell hardness of 40 H_{R}C) and had a diameter of φ10 mm.

The aluminum-alloy plate 1 and the soft-alloy plate 2 were joined to each other in accordance with the same procedures as described in Example No. 1-1, except that the steel round bar was pressed into the aluminum-alloy plate 1 by a pressing magnitude “D” of 0.6 mm. Two joined bodies were thus made. However, the joined bodies were provided with a dent at the joint, respectively. The removal of the tool-steel round bar resulted in the dent. The dent had a dimension of 1.35 mm at the thinnest section in which the aluminum-alloy plate 1 accounted for 0.55 mm and the soft-steel plate 2 accounted for 0.8 mm. The dent occurred because the tool-steel round bar had not softened at the friction-stir-joining step.

### Example No. 2-1

As the plate-shaped workpieces to be joined, an identical aluminum-alloy plate 1 was prepared in a quantity of two pieces. Note that the aluminum-alloy plate 1 was made of the “A6061” aluminum alloy and had 1-mm thickness “T₁.” The two aluminum-alloy plates 1 were subjected to joining in the same manner as Example No. 1-1. In Example No. 2-1, however, note that the aluminum-alloy round bar 3 was pressed into the upper aluminum-alloy plate 1 with an axial pressure of about 100 MPa.

### Example No. 2-2

As the plate-shaped workpieces to be joined, an identical aluminum-alloy plate 1 was prepared in a quantity of two pieces. Note that the aluminum-alloy plate 1 was made of the “A6061” aluminum alloy and had 1-mm thickness “T₁.” The two aluminum-alloy plates 1 were subjected to joining in the same manner as Example No. 1-2.

### Comparative Example No. 2

As the plate-shaped workpieces to be joined, an identical aluminum-alloy plate 1 was prepared in a quantity of two pieces. Note that the aluminum-alloy plate 1 was made of the “A6061” aluminum alloy and had 1-mm thickness “T₁.” However, as the rod-shaped body, the same tool-steel round bar as that was used in Comparative Example No. 1 was prepared. Then, the two aluminum-alloy plates 1 were subjected to joining in the same manner as Comparative Example No. 1.

### Evaluation

Each of the joined bodies being made as described above was subjected to a tensile test to measure the tensile shear strength. Note that the tensile test was carried out under the conditions as prescribed in JIS Z 3136 on the tensile test for spot welded joint. Tables land 2 below give the test results. Also note that the values of the tensile shear strength being set forth in the tables are their averaged values because a plurality of the joined bodies were made in each of Example Nos. 1-1, 1-2, 2-1 and 2-2, and in each of Comparative Example Nos. 1 and 2.

TABLE 1

| | | | Rod- | | | |
|---|---|---|---|---|---|---|
| | | | shaped | Number of | Pressing | |
| | Top | Bottom | Work- | Revolutions | Magnitude | Strength |
| | Plate | Plate | piece | (rpm) | (mm) | (kN) |
| Ex. | A6061 | SPC | A2017 | 1000 | 0.8-1.2 | 2.93 |
| No. | | | | | | |
| 1-1 | | | | | | |
| Ex. | A6061 | SPC | A2017 | 1000 | 1.4 | 4.84 |
| No. | | | | | | |
| 1-2 | | | | | | |
| Comp. | A6061 | SPC | Tool | 1000 | 0.6 | 2.37 |
| Ex. | | | Steel | | | |
| No. 1 | | | | | | |

The joined bodies according to Comparative Example No. 1 that were made by means of the conventional method exhibited a tensile shear strength of 2.37 kN at the joint on average. Moreover, after the tensile test, all of the joined bodies had undergone come-off (or shear fracture) at the boundary surface. In addition, in the joined bodies according to Comparative Example No. 1, the “A6061” aluminum alloy adhered thinly on the fractured surface on the side of the soft-steel plate 2. Accordingly, it is believed that the “A6061” aluminum alloy (i.e., a first metal) was stirred “indirectly,” though the rotary friction between the tool-steel round bar 3 and the aluminum-alloy plate 1 raised the temperature of the “A6061” aluminum alloy and simultaneously the “A6061” aluminum alloy receiving the rotary force was stirred. Consequently, it is believed that, even when the coalescence occurred between the aluminum-alloy plate 1 and the tool-steel round bar 3, it did not result in firm joining at all.

On the contrary, the joined bodies according to Example No. 1-1 exhibited a tensile shear strength of 2.93 kN at the joint on average. That is, they were joined together more firmly than they were joined together by means of the conventional method. Moreover, the joined bodies according to Example No. 1-2 exhibited a considerably high tensile shear strength of 4.84 kN at the joint on average. As can be appreciated from FIG. 5 and FIGS. 7 through 9, the joined bodies according to Example Nos. 1-1 and 1-2 were provided with the built-up section “3j.” The “A2017” aluminum-alloy round bar 3 that was press fitted into the “A6061” aluminum-alloy plate 1 made the built-up section “3j.” In addition, the “A6061” aluminum alloy (i.e., a first metal) that was mixed with the “A2017” aluminum alloy (i.e., a third metal) was connected with the “A6061” aluminum alloy, which came in contact with the surface of the soft-steel plate 2, in a solid-phase state. Accordingly, the “A6061” aluminum alloy was stirred “directly” by the rotating aluminum-alloy round bar 3, and thereby the oxidized film on the aluminum-alloy plate 1 was fractured or divided into pieces. Consequently, it is believed that the aluminum-alloy plate 1 coalesced with the soft-steel plate 2 efficiently.

In particular, it is believed that, in the joined bodies according to Example No. 1-2, plastic deformation that was accompanied by great deformation occurred so that an aluminum layer with an exposed newly-generated surface of the “A6061” aluminum alloy was formed. Moreover, the resulting aluminum layer was stirred by the rotating aluminum-alloy round bar 3 efficiently so as to integrate with the “A2017” aluminum alloy that made the aluminum-alloy round bar 3. As a result, it is believed that the aluminum-alloy plate 1 and the soft-steel plate 2 were joined together firmly to each other.

TABLE 2

| | | | Rod- | | | |
|---|---|---|---|---|---|---|
| | | | shaped | Number of | Pressing | |
| | Top | Bottom | Work- | Revolutions | Magnitude | Strength |
| | Plate | Plate | piece | (rpm) | (mm) | (kN) |
| Ex. | A6061 | A6061 | A2017 | 1000 | 0.8-1.0 | 3.80 |
| No. | | | | | | |
| 2-1 | | | | | | |
| Ex. | A6061 | A6061 | A2017 | 1000 | 1.4 | 4.97 |
| No. | | | | | | |
| 2-2 | | | | | | |
| Comp. | A6061 | A6061 | Tool | 1000 | 0.6 | 2.67 |
| Ex. | | | Steel | | | |
| No. 2 | | | | | | |

Even when the joined bodies according to Example Nos. 2-1 and 2-2 comprised the plate-shaped workpieces 1 that were made of the same material species, they exhibited a higher tensile-shear-strength value at the joint on average than the averaged value of the joined bodies according to Comparative Example No. 2 that were made by means of the conventional method.

Note that, in the joined bodies according to Comparative Example No. 2, the fracture after the tensile test was found to be plug fracture toward the top plate, namely, to the side that the tool-steel round bar 3 was pressed in. In other words, it was understood that, in the joined bodies according Comparative Example No. 2, the joint was thinned out to exhibit low strength against plug fracture. On the other hand, in the joined bodies according to Example No. 2-1, the fracture after the tensile test was found to be shear fracture between the two aluminum-alloy plates 1. Moreover, in the joined bodies according to Example No. 2-2, plug fracture toward the bottom plate was observed after the tensile test. Thus, it was ascertained that the joined bodies according to Example No. 2-2 comprised the two aluminum-alloy plates 1 that were joined together firmly at the joint to each other.

Having now fully described the present invention, it will be apparent to one of ordinary skill in the art that many changes and modifications can be made thereto without departing from the spirit or scope of the present invention as set forth herein including the appended claims.

What is claimed is:

1. A joined body having a joint,
the joint comprising:
a first plate-shaped workpiece comprising a first metal;
a second plate-shaped workpiece comprising a second metal; and
at least a part of the first plate-shaped workpiece and at least a part of the second plate-shaped workpiece being overlapped each other;
the joint being made by joining the first plate-shaped workpiece and the second plate-shaped workpiece to each other by means of friction stir joining, wherein a rod-shaped body comprising a third metal is disposed at a part where the first plate-shaped workpiece and the second plate-shaped workpiece overlap each other, and then the first plate-shaped workpiece and the second plate-shaped workpiece are rotated relatively with respect to the rod-shaped body while pressing the rod-shaped body onto the first plate-shaped workpiece; and
the joint further comprising:
a coalesced section being made of the first metal that coalesces on a surface of the second plate-shaped workpiece;
a built-up section being made of a leading end of the rod-shaped body that is buried in the first plate-shaped workpiece; and
a composite section being disposed between the coalesced section and the built-up section, and being made of the first metal and the third metal that are intermingled with each other, thereby integrating the coalesced section with the built-up section.

2. The joined body according to claim 1, wherein both of the first metal and the third metal comprise a metal that softens and then fluidizes by means of heat generation resulting from friction.

3. The joined body according to claim 1, wherein at least the first metal and the third metal comprise an identical metallic element as a major component.

4. The joined body according to claim 3, wherein:
the first metal and the third metal comprise aluminum or an aluminum alloy; and
the second metal comprises iron or a steel.

5. The joined body according to claim 3, wherein the first metal, the second metal and the third metal comprise aluminum or an aluminum alloy.

6. A process for manufacturing joined body, the process comprising the steps of:
fixing a first plate-shaped workpiece comprising a first metal and a second plate-shaped workpiece comprising a second metal in such a state that at least a part of the first plate-shaped workpiece and at least a part of the second plate-shaped workpiece are overlapped each other; and
subjecting the first plate-shaped workpiece and the second plate-shaped workpiece to friction stir joining, wherein a rod-shaped body comprising a third metal is disposed at a part where the first plate-shaped workpiece and the second plate-shaped workpiece overlap each other, and then the first plate-shaped workpiece and the second plate-shaped workpiece are rotated relatively with respect to the rod-shaped body while pressing the rod-shaped body onto the first plate-shaped workpiece, thereby softening and then fluidizing both of the first metal and the third metal by means of heat generation resulting from friction between the first plate-shaped workpiece and the rod-shaped body so as to coalesce the softened first metal onto a surface of the second plate-shaped workpiece and build up the first plate-shaped workpiece with the softened third metal.

7. The manufacturing process according to claim 6 further comprising, before the fixing step, a step of providing the first plate-shaped workpiece with a through hole with a circular cross-sectional shape, the through hole having a smaller diameter than that of the rod-shaped body and penetrating the first plate-shaped workpiece in the thickness-wise direction, wherein:
the fixing step comprises a step of superimposing the through hole over a surface of the second plate-shaped workpiece; and
the step of subjecting the first plate-shaped workpiece and the second plate-shaped workpiece to friction stir joining comprises a step of press fitting the rod-shaped body into the through hole.

8. The manufacturing process according to claim 6, wherein at least the first metal and the third metal comprise an identical metallic element as a major component.

9. The manufacturing process according to claim 7, wherein at least the first metal and the third metal comprise an identical metallic element as a major component.

10. The manufacturing process according to claim 8, wherein:
the first metal and the third metal comprise aluminum or an aluminum alloy; and
the second metal comprises iron or a steel.

11. The manufacturing process according to claim 9, wherein:
the first metal and the third metal comprise aluminum or an aluminum alloy; and
the second metal comprises iron or a steel.

12. The manufacturing process according to claim 8, wherein the first metal, the second metal and the third metal comprise aluminum or an aluminum alloy.

13. The manufacturing process according to claim 9, wherein the first metal, the second metal and the third metal comprise aluminum or an aluminum alloy.

14. The manufacturing process according to claim 7, wherein the through hole has an inside diameter that is smaller than an outside diameter of the rod-shaped body by a factor of from 0.3 to 0.9.
